(19) United States
(12) Patent Application Publication
(10) Pub. No.: US 2026/0369287 A1
(43) Pub. Date: Nov. 19, 2026

(54) VOICE COMMUNICATIONS FOR ELECTRONIC DEVICES

(71) Applicant: Apple Inc., Cupertino, CA (US)

(72) Inventors: Jonathan D. SHEAFFER, San Jose, CA (US); Andrew P. BRIGHT, Los Gatos, CA (US); Brian P. HAMILTON, Pacifica, CA (US); Matthew M. O'CONNOR, Santa Cruz, CA (US); Peter KROON, Green Brook, NJ (US); Sivanand ACHANTA, San Jose, CA (US)

(21) Appl. No.: 19/551,460

(22) Filed: Feb. 26, 2026

Related U.S. Application Data
(60) Provisional application No. 63/805,977, filed on May 14, 2025.

(51) Int. Cl. G10L 21/00; G10L 15/26; G10L 19/00

(52) U.S. Cl. CPC G10L 21/00; G10L 15/26; G10L 19/00

(57) ABSTRACT

Efficient voice communications for electronic devices may be provided, including in extremely low-bandwidth network environments with data rates below a few kilobits per second. A voice model may reconstruct a portion of a voice input received at another device, in the voice of the user that spoke the voice input at the other device, using a transcription of that portion of the voice input. The voice model may also take, as inputs, an audio snippet of another portion of the voice input and/or one or more encodings of audio features of the voice of the user of the other device. In this way, the voice input of a user of a remote device can be output by a speaker of a local device, even if audio data for some or all of the voice input of the user is not received or available at the local device.

### CROSS REFERENCE TO RELATED APPLICATIONS

This application claims the benefit of priority to U.S. Provisional Patent Application No. 63/805,977, entitled, “Voice Communications for Electronic Devices”, filed on May 14, 2025, the disclosure of which is hereby incorporated herein in its entirety.

### TECHNICAL FIELD

The present description relates generally to electronic devices, including, for example, voice communications for electronic devices.

### BACKGROUND

Telephones and smart phones are often used to transmit and receive audio data that represents a human voice, as part of a telephone call or a video conference. These transmissions of audio data over wired or wireless connections typically consume large amounts of bandwidth.

### BRIEF DESCRIPTION OF THE DRAWINGS

Certain features of the subject technology are set forth in the appended claims.

However, for purpose of explanation, several aspects of the subject technology are set forth in the following figures.

FIG. 1 illustrates a perspective view of an example electronic device in accordance with various aspects of the subject technology.

FIG. 2 is a schematic diagram of an example of a high-bandwidth network environment in accordance with various aspects of the subject technology.

FIG. 3 is a schematic diagram of an example of a low-bandwidth network environment in accordance with various aspects of the subject technology.

FIG. 4 is a schematic diagram of another example of a high-bandwidth network environment in accordance with various aspects of the subject technology.

FIG. 5 is a schematic diagram of another example of a low-bandwidth network environment in accordance with various aspects of the subject technology.

FIG. 6 is a schematic block diagram of an electronic device performing exemplary operations to generate a hybrid voice transmission based on a local user voice input in accordance with various aspects of the subject technology.

FIG. 7 is a schematic block diagram of an electronic device performing other exemplary operations to generate a hybrid voice transmission based on a local user voice input in accordance with various aspects of the subject technology.

FIG. 8 illustrates an example of a voice input for which first and second portions may be used, respectively, to generate audio data and transcription data in accordance with various aspects of the subject technology.

FIG. 9 illustrates an example of a voice input for which first and second portions may be used, respectively, to generate an encoding and transcription data in accordance with various aspects of the subject technology.

FIG. 10 is a schematic block diagram of an electronic device generating a remote user voice output based on a hybrid voice transmission in accordance with various aspects of the subject technology.

FIG. 11 is a flow chart of illustrative operations that may be performed for generating a remote user voice output based on a hybrid voice transmission in accordance with various aspects of the subject technology.

FIG. 12 is a flow chart of other illustrative operations that may be performed for generating a hybrid voice transmission based on a local user voice input in accordance with various aspects of the subject technology.

FIG. 13 is another flow chart of illustrative operations that may be performed for generating a remote user voice output based on a hybrid voice transmission in accordance with various aspects of the subject technology.

FIG. 14 illustrates an electronic system with which one or more implementations of the subject technology may be implemented.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology.

However, it will be clear and apparent to those skilled in the art that the subject technology is not limited to the specific details set forth herein and may be practiced without these specific details. In some instances, well-known structures and components are shown in block diagram form in order to avoid obscuring the concepts of the subject technology.

Electronic devices, including portable electronic devices such as a mobile phones, portable music players, tablet computers, laptop computers, wearable devices such as smart watches, smart glasses, head mountable devices (HMDs), headphones, earbuds, other wearable devices, and the like, often used to transmit and receive audio data for exchanging voice communications between remote users (e.g. including during telephone calls, audio conferences, video conferences, and/or walkie-talkie communications). However, voice communications between remote devices can fail in low-bandwidth network environments (e.g., with bandwidths below, for example, a few hundred bits per second).

Aspects of the subject technology may provide efficient communication of voice data between a sending device and a receiving device by leveraging one or more voice models at the receiving device. This can be particularly helpful when voice data is being transmitted by satellite, or in some other bandwidth-constrained wireless environment. For example, only a portion (e.g., a snippet) of a voice input received by a first device may be transmitted as audio data to a second device. For the remainder of the voice input, a transcription may be generated at the first device and sent as text to the second device. In various examples described hereinafter, a hybrid voice transmission may be transmitted, the hybrid voice transmission including (i) the audio data for the snippet of the voice input and (ii) the transcription of the remainder of the voice input. Because a transcription of audio data includes far less data than the audio data itself, the transcription (e.g., and/or a hybrid voice transmission including the transcription) can be transmitted using significantly less bandwidth than transmitting the audio data for the entire voice input.

The second device may then use one or more voice models to reconstruct the full voice input, from the audio snippet and the transcription, for output by a speaker at the second device. In some implementations, with the explicit permission of the user of the first device, the voice model(s) at the second device may have been previously trained on the actual voice of the user of the first device. For example, a trusted cohort of users may store voice models of each other's voices on their devices, for use in this way.

In some implementations, no audio snippet may be sent, and instead only an encoding (e.g., an encoding of prosodic or other features of the user's voice) may be sent with the transcription. In these implementations, the entire audio of the voice input may be reconstructed at the receiving device (e.g., using a voice model previously trained on the voice of the user) based on a hybrid voice transmission that includes the encoding and a transcription of the voice input (e.g., without any audio snippet data).

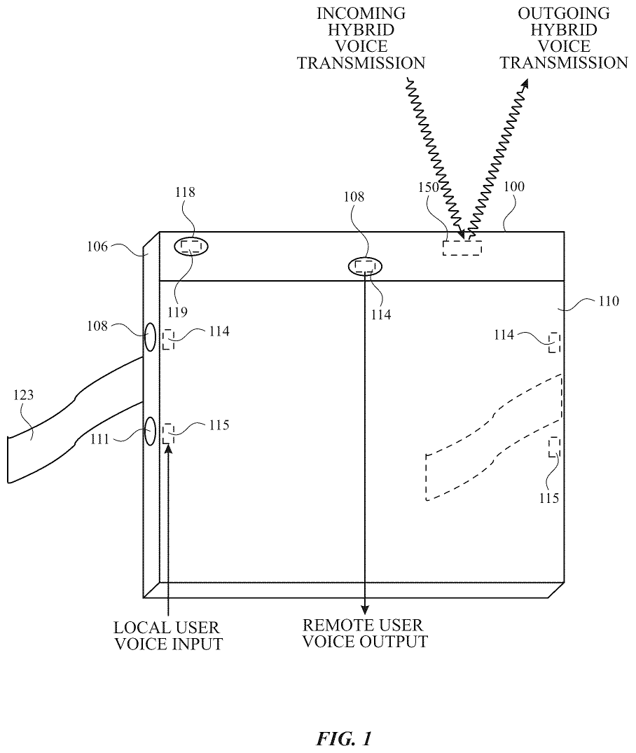

An illustrative electronic device is shown in FIG. 1. In the example of FIG. 1, electronic device 100 has been implemented using a housing that is sufficiently small to be portable and carried or worn by a user. For example, electronic device 100 of FIG. 1 may be a handheld electronic device such as a tablet computer, a cellular telephone or smart phone, a wearable device such as a smart watch, smart glasses, a smart ring, a head mountable device (HMD), a pendant device, a headlamp device, or the like. In the example of FIG. 1, electronic device 100 includes a display such as display 110 mounted to a housing 106 (e.g., a frame).

Electronic device 100 may include one or more input components, such as a touch screen incorporated into display 110, a button, a switch, a dial, a crown, one or more microphones 115, one or more cameras such as camera 119, and/or other input components. The input components may be disposed on or behind the display 110 and/or on, within, or behind portions of housing 106. Display 110 and/or housing 106 may include one or more openings to accommodate one or more buttons, speakers, microphones, light sources, and/or cameras (as examples). In various implementations, display 110 may be an opaque display or a transparent display (e.g., a display through which a user can directly view their physical environment, and on which display content can be displayed and/or projected, such as to appear in combination with the user's direct view of the physical environment).

In the example of FIG. 1, housing 106 (e.g., a frame and/or an enclosure) includes openings, such as openings 108, openings 111, and/or opening 118. For example, openings 108 may form ports for one or more respective speakers 114. In the example of FIG. 1, the openings 108 form speaker ports for speakers 114 disposed within the housing 106.

In various implementations, the housing 106 and/or the display 110 may also include other openings, such as openings for one or more input components, such as one or more microphones 115, one or more pressure sensors, one or more cameras 119 (e.g., visible light cameras, infrared cameras, color imagers, monochrome imagers), depth sensors, and/or other components that receive and/or provide signals from and/or to the environment external to the housing 106. In the example of FIG. 1, the openings 111 form ports for respective microphones 115.

Although three openings 108, an opening 111, and an opening 118 are shown in FIG. 1, this is merely illustrative. One opening 108, two openings 108, or more than two openings 108 may be provided on any of various surfaces of the housing 106 for one speaker 114, two speakers 114, or more than two speakers 114. One opening 111, two openings 111, or more than two openings 111 may be provided on any of various surfaces of the housing 106 for one microphone 115, two microphones 115, or more than two microphones 115.

In some implementations, one or more groups of openings in housing 106 and/or groups of openings may be aligned with a single port of an input component within housing 106. Housing 106, which may sometimes be referred to as a case, an enclosure, or a frame, may be formed of plastic, glass, ceramics, fiber composites, metal (e.g., stainless steel, aluminum, etc.), other suitable materials, or a combination of any two or more of these materials.

In one or more implementations, two or more speakers 114 may be operable to spatialize an audio output of the electronic device 100 to be perceived, by a user or wearer of the electronic device 100, as originating from a location remote from the speakers 114 and/or the electronic device 100 (e.g., including perceived locations within the head of the user and/or perceived locations in the external environment of the electronic device outside the head of the user and remote from the electronic device 100).

The configuration of electronic device 100 of FIG. 1 is merely illustrative. In other implementations, electronic device 100 may be a computer such as a computer that is integrated into a display such as a computer monitor, a laptop computer, a media player, a gaming device, a navigation device, a computer monitor, a television, a headphone, an earbud, or other electronic equipment having at least one speaker and one or more input components. As discussed herein, in some implementations, electronic device 100 may be provided in the form of a wearable device such as a smart watch, a head mountable device, a smart ring, or smart glasses. In one or more implementations, housing 106 may include one or more interfaces for mechanically coupling housing 106 to one or more structures 123 (e.g., straps, arms, or other attachment mechanisms) that is configured for securing housing 106 to a wearer (e.g., to a wrist or a head of the wearer).

As illustrated in FIG. 1, in one or more use cases, the microphone(s) 115 of the electronic device 100 may be used to receive a local user voice input from a local user of the electronic device 100 (e.g., the local user may speak toward and/or in the vicinity of the electronic device 100, and a resulting voice input may be received by the microphone(s) 115).

As discussed in further detail hereinafter, the electronic device 100 may generate (e.g., using communications circuitry 150 of the electronic device 100) an outgoing hybrid voice transmission based on the local user voice input, and may transmit the outgoing hybrid voice transmission (e.g., wirelessly), such as to a remote device of another user (e.g. a remote user).

For example, the local user may desire to speak to the remote user (e.g., in a telephony operation, a conferencing operation, or a walkie-talkie operation via the electronic device 100). As discussed in further detail hereinafter, the outgoing hybrid voice transmission may include transcription data corresponding to a transcription of at least a portion of the local user voice input received by the microphone(s) 115, and audio data and/or one or more encodings of at least another portion of the local user voice input (e.g., without including audio data for at least some of the local user voice input).

As shown, the electronic device 100 may also receive (e.g., with the communications circuitry 150) an incoming hybrid voice transmission. For example, the incoming hybrid voice transmission may include audio data and/or one or more encodings corresponding to a first portion of a remote user voice input received at a remote device, and a transcription of at least a second portion of the remote user voice input received at the remote device. As discussed in further detail hereinafter, the electronic device 100 may generate (e.g., with one or more of the speakers 114) a remote user voice output based on the incoming hybrid voice transmission.

Although FIG. 1 depicts an example in which outgoing hybrid voice transmissions are sent by the electronic device 100 and incoming hybrid voice transmissions are received by the electronic device 100, this is merely illustrative. In some use cases (e.g., when a communication link between the electronic device 100 and a remote device is asymmetrical in terms of bitrate capacity) one or the other of the incoming and outgoing voice transmissions may be received or sent entirely as audio data.

The communications circuitry 150 may include one or more antennas and/or control circuitry (e.g., radio frequency (RF) front end circuitry including one or more transceivers) that operates the one or more antennas to transmit and/or receive wireless communications. As examples, the communications circuitry 150 may include one or more wireless interfaces, such as WLAN radios, cellular radios, Bluetooth radios, Thread radios, Zigbee radios, near field communication (NFC) radios, satellite radios, and/or other wireless radios, such as for wireless communications with one or more remote devices directly or via intervening devices and/or servers.

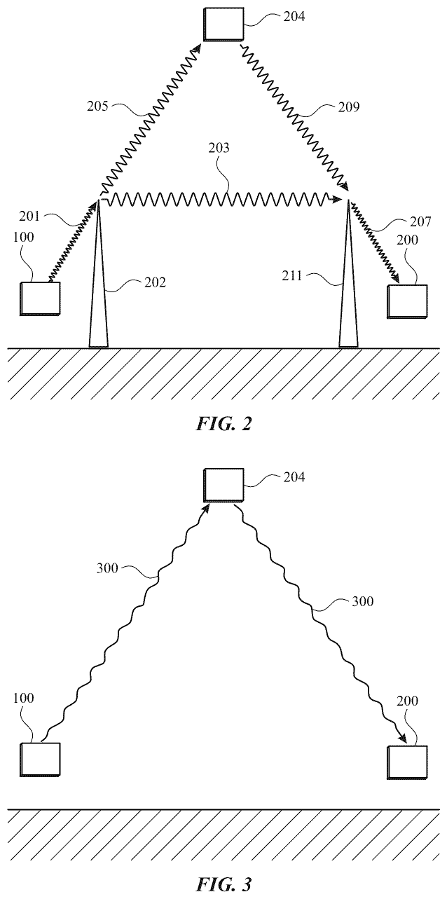

For example, FIG. 2 illustrates a wireless communication from the electronic device 100 (e.g., a local device in this example) to a remote device 200 via intervening high power transmitters (e.g., cell towers, Wi-Fi routers or the like). In the example of FIG. 2, the electronic device 100 transmits a wireless communication 201 to a cell tower 202 (e.g., or other high-power transmitter), which may transmit a corresponding wireless transmission 203 (e.g., a wired and/or wireless transmission) to another cell tower 211 or a corresponding wireless transmission 205 to a satellite 204. The other cell tower 211 may receive the wireless transmission 203 from the cell tower 202 or may receive a corresponding wireless transmission 209 from the satellite 204, and, responsively, transmit a wireless communication 207 to the remote device 200. In this example, because the cell tower 202 is relatively close to the electronic device 100 and the other cell tower 211 is relatively close to the remote device 200, and because the cell tower 202 and the other cell tower 211 may be capable of high-power and/or high-bandwidth communications that convey the data in the wireless communication 201 from the electronic device 100 across most of the distance between the electronic device 100 and the remote device 200, the communication environment illustrated in FIG. 2 may be considered a high-bandwidth network environment (e.g., capable of transmitting, on average, more than a few hundred bits per second, such as tens, hundreds, or thousands of bits per second, such as between ten and thirty kilobits per second). In one or more use cases, in a high-bandwidth network environment such as that of FIG. 2, the electronic device 100 may transmit voice data entirely in the form of audio data.

However, in other network environments, such as a low-bandwidth network environment, the electronic device 100 may instead transmit voice data in the form of a hybrid voice transmission. For example, FIG. 3 illustrates a network environment in which the only available communication path between the electronic device 100 and the remote device 200 is via direct communication between the electronic device 100 and a satellite 204. In this example, a wireless connection between the electronic device 100 and the satellite 204 (e.g., and/or between the satellite 204 and the remote device 200) may only be capable of handling data rates, on average, of a few hundred bits per second (e.g., less than one kilobit per second or less than five hundred bits per second). In a use case in which the electronic device 100 receives a voice input and a request from a user to transmit that voice input to the remote device 200 while in the low-bandwidth network environment of FIG. 3, the electronic device 100 may generate a hybrid voice communication 300 and transmit that hybrid voice communication 300 to the satellite 204. As shown on the satellite 204 may relay the hybrid voice communication 300 to the remote device 200. In this example, the remote device 200 may reconstruct (e.g., using a voice model at the remote device 200) a voice output corresponding to the voice input received at the electronic device 100, using the hybrid voice communication 300 received from the electronic device 100 via the satellite 204.

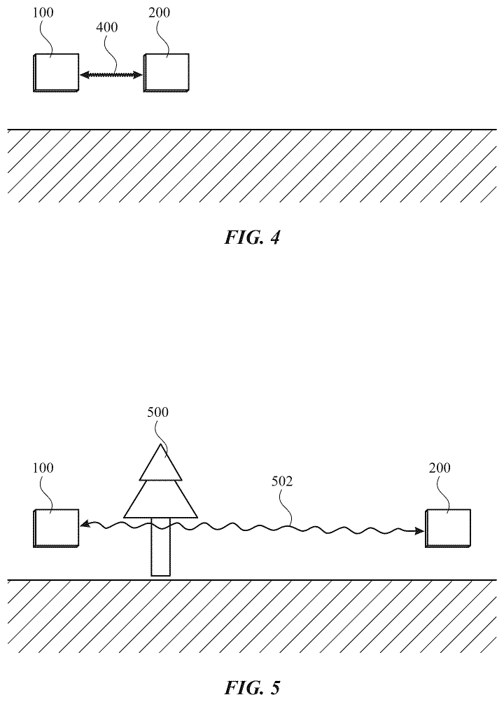

FIGS. 4 and 5 illustrate additional examples of respective high-bandwidth and low-bandwidth network environments in which the electronic device 100 communicates with the remote device 200. For example, in FIG. 4, the electronic device 100 and the remote device 200 may be in close physical proximity (e.g., within a few inches, a few feet, or a few yards or meters) of each other, such as within a Bluetooth, NFC, or direct Wi-Fi communication range of each other, and may directly exchange (e.g., high-bandwidth) audio data 400 with each other. In this example, the electronic device 100 may transmit voice data entirely in the form of audio data. However, as shown in FIG. 5, in some use cases, direct communication between the electronic device 100 and the remote device 200 may occur when the electronic device 100 and the remote device 200 are relatively further from each other (e.g., tens of yards or hundreds of yards apart), and/or, one or more physical barriers 500 (e.g., trees, buildings, mountains, and/or other physical structures that may impede wireless communications) are interposed between the electronic device 100 and the remote device 200. In these example use cases, the data rate achievable directly between the electronic device 100 and the remote device 200 may be significantly reduced, and the electronic device 100 may transmit voice data in the form of a hybrid voice communication 502. In one or more implementations, the electronic device 100 may determine the available bandwidth and or data rate for communication with the remote device 200, and may determine whether to send voice data as audio data or as a hybrid voice communication based on the determination of the available bandwidth and or data rate.

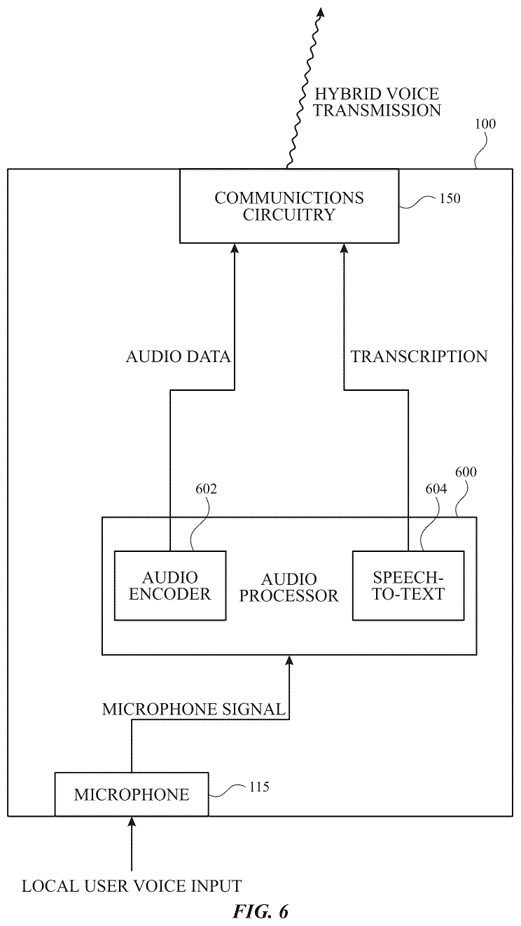

FIG. 6 illustrates a schematic block diagram of the electronic device 100 in a use case in which the electronic device 100 is generating a hybrid voice transmission based on a local user voice input. In the example of FIG. 6, a local user voice input is received at the electronic device 100 using one or more microphones 115. For example, the local user voice input may correspond to the sound of the voice of a local user while the local user is speaking. For example, a local user may be speaking a message to a remote user of the remote device 200. As shown, responsive to the local voice input, the microphone 115 generates a microphone signal. As shown, the microphone signal may be provided to an audio processor 600 at the electronic device 100. In the example of FIG. 6, the audio processor 600 includes an audio encoder 602 and a speech-to-text block 604. Each of the audio encoder 602 and the speech-to-text block 604 may receive the microphone signal from the microphone 115.

The audio encoder 602 may apply an audio codec to a first portion of the microphone signal to generate audio data corresponding to the first portion of the microphone signal. Speech-to-text block 604 may generate a transcription of a second portion of the microphone signal. As shown, the audio data and the transcription may be provided to the communication circuitry 150 for transmission as a hybrid voice transmission (e.g., or combined into a hybrid signal by the audio processor and then provided to the communications circuitry for transmission). In this example, the first portion of the microphone signal that is encoded, by the audio encoder 602, into the audio data may be less than all of the microphone signal, such as a snippet in time of a first second, few seconds, or fraction of a second of the microphone signal.

In this example, the second portion of the microphone signal that is transcribed into the transcription by the speech-to-text block 604 may be a remaining portion of the microphone signal that is not encoded into the audio data. By reducing the amount of the microphone signal that is encoded into audio data for transmission in this way, the amount of data to be transmitted to convey the local user voice input to the remote device 200 may be significantly reduced (e.g., by one or more orders of magnitude), while still conveying sufficient information for the remote device 200 to reconstruct an audio output that sounds at least similar to the local user speaking the local user voice input. In one or more implementations, the hybrid voice transmission may be transmitted to a remote device at an average bit rate of, for example, around (or less than) five hundred bits per second. For example, the audio portion of the hybrid voice transmission may be transmitted (e.g., during short durations of, for example, high or peak rate availability) at bit rates of between eight hundred and twelve hundred bits per second, and the transcription portion (e.g., including transcription text and/or accompanying semantics and/or other encodings), may be transmitted at bit rates as low as two hundred bits per second.

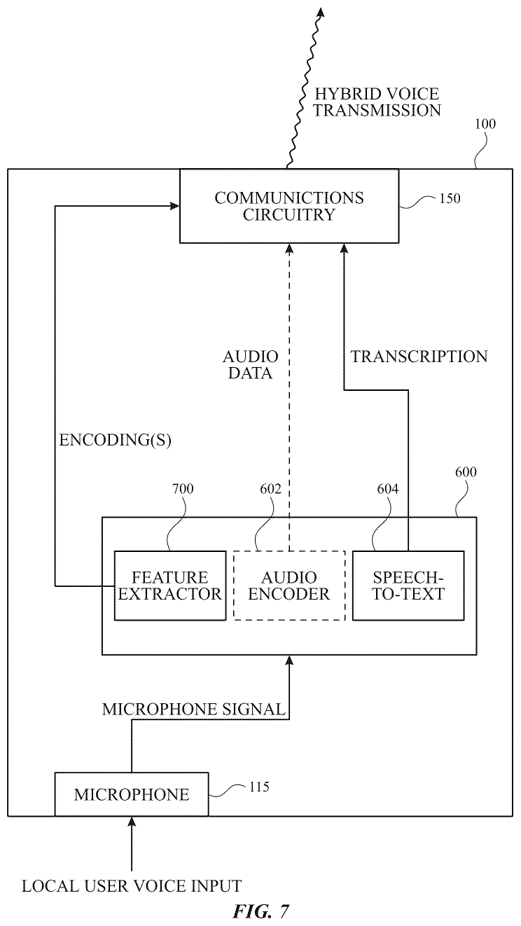

In the example of FIG. 6, a portion of the local user voice input (e.g., a portion of the microphone signal generated by the microphone 115 responsive to the local user voice input) is still encoded into audio data. However, as shown in FIG. 7, in some implementations, a hybrid voice communication may be generated from the local user voice input without including any audio data. For example, the audio processor 600 may be provided with one or more feature extractors, such as the feature extractor 700. The feature extractor 700 may generate one or more encodings corresponding to audio features of the local user voice input from the microphone signal received from the microphone 115. As examples, the feature extractor 700 may receive the microphone signal from the microphone 115, and, responsively, generate one or more of a prosody encoding, a semantic encoding, a tone encoding, a stress encoding, a rhythm encoding, and/or a timbre encoding.

For example, the prosody encoding may encode one or more prosodic characteristics of the voice of the local user. For example, the semantic encoding may encode one or more semantic features of the speech of the local user. For example, the tone encoding may encode one or more features of one or more tones generated by the local user's voice. For example, the stress encoding may encode one or more stress features of the local user's voice. For example, the rhythm encoding may encode one or more features of the rhythm of the local user's voice.

For example, the timbre encoding may encode one or more features of the timbre of the local user's voice. These encodings may be generated based on the local user voice input (e.g., rather than, or in addition to, pre-prepared encodings based on prior local user voice inputs) so that the characteristics of the local user's voice when speaking the local user voice input are reflected in the encodings. For example, the local user may be stressed, relaxed, angry, happy, worried, out of breath, and/or in one or more other physical conditions that affect the current characteristics of the local user's voice when speaking the local user voice input. Generating the encodings with the feature extractor 700 at the time the local user voice input is received, may help the remote device 200 accurately reflect the current sound of the local user's voice and any corresponding current physical condition of the local user in a reconstructed version of the local user's voice input. In one or more implementations, the feature extractor 700 may include an ambience extractor configured to generate one or more ambience encodings that describe one or more non-speech background noises represented in the microphone signal from the microphone 115. In order, for example, to give environmental context to the generated voice at the remote device 200, the remote device 200 may regenerate (e.g., in combination with regenerating the speech of the local user) the one or more non-speech background noises based on one or more ambience encodings that are included in the hybrid voice transmission. For example, the remote device may use the ambience encoding(s) to regenerate non-speech background noises in a generic sense. For example, if a dog barks in the vicinity of the local user while the local using is providing the local user voice input, a dog bark may be generated at the remote device 200 based on an ambience encoding describing the dog bark, though the regenerated dog bark may not necessarily be similar to the dog bark that occurred in the vicinity of the local user.

In one or more implementations, the one or more encodings generated by the feature extractor 700, along with the transcription generated by the speech to text block 604, may be sufficient for the remote device 200 to reconstruct the entirety of the local user voice input without receiving any audio data from the electronic device 100. However, as shown in FIG. 7, in one or more implementations, audio data (e.g., corresponding to a snippet of the local user voice input) may also be generated by the audio processor 600 and included in the hybrid voice transmission with the encoding(s) and the transcription. For example, including the audio data along with one or more encodings from the feature extractor 700 may improve the ability of the remote device 200 to accurately reproduce the sound of the voice of the local user.

It is appreciated that, while the audio data that is generated by the audio encoder 602 is also an encoding corresponding a portion of the local user voice input, the encoded audio data is different from the encoding(s) generated by the feature extractor 700 at least in that an audio encoding is sufficient, on its own, to generate an audio output that includes both the content and the sound of the local user's voice speaking that portion of the local user voice input. In contrast, the encoding(s) generated by the feature extractor 700 represent only acoustic features and/or sematic features of the voice and/or speech of the local user, without including any information about the content of the local user's speech. Accordingly, the encodings generated by the feature extractor 700 may be insufficient, on their own (e.g., or even in combination with each other) to reconstruct the local user voice input. In these examples, the content of the user's speech is carried in the transcription, which itself does not include any information that could be used to represent the sound of any individual user. That is, the transcription could be used to generate an audio output of the content of the local user voice input in a generic voice that is unrelated to the voice of the local user, but the transcription does not include sufficient information to mimic the voice of the local user.

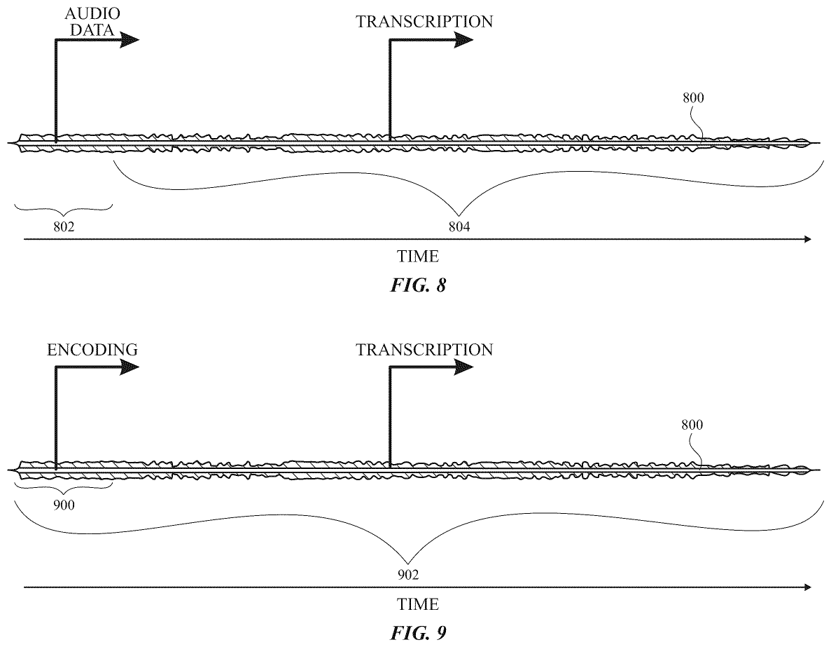

As discussed herein, the audio encoder 602 may generate audio data from a first portion of the local user voice input, and the speech-to-text block 604 may generate a transcription from a second portion of the local user voice input. For example, FIG. 8 illustrates an example of a voice input 800 (e.g., represented as a microphone signal), showing how a first portion 802 (e.g., in time) of the voice input 800 may be encoded into an audio output, and a second portion 804 (e.g., in time) of the voice input 800 may be used to generate the transcription. As shown, the first portion 802 may be significantly shorter (e.g., less than fifty percent, less than twenty percent, or less than ten percent) than the second portion 804 and/or of a total time of the voice input 800. For example, the local user voice input 800 may be a twenty or thirty second voice message, and the first portion 802 may be a one or two second snippet of the twenty or thirty second voice message. In this way, the amount of audio data that is transmitted to convey the local user voice input 800 can be significantly reduced. In various implementations, the audio encoder 602 may use a standard audio codec, a custom audio codec, or a machine learning audio codec to encode the first portion of the local user voice input 800 into the audio data.

As discussed herein, the feature extractor 700 may generate one or more encodings from a first portion of the local user voice input, and the speech-to-text block 604 may generate a transcription from a second portion of the local user voice input. For example, FIG. 9 illustrates an example of the voice input 800 (e.g., represented as a microphone signal), showing how a first portion 900 (e.g., in time) of the voice input 800 may be encoded into an encoding, and a second portion 902 (e.g., in time) of the voice input 800 may be used to generate the transcription. In this example, no audio data is generated, and the second portion 902 spans the entire length of the local user voice input 800. In this example, the second portion 902 overlaps at least some of the first portion 900 that is used to generate the encoding. In this example, the first portion 900 is significantly shorter (e.g., less than fifty percent, less than twenty percent, or less than ten percent) than the second portion 902. However, in use cases in which no audio data is transmitted, the first portion 900 may be a relatively larger fraction of the local user voice input 800 than the first portion 802 in cases in which an audio data snippet is generated. Because the encoding(s) may include less data than an audio encoding, using a larger first portion 900 may not increase the amount of data to be transmitted (e.g., relative to the case in which audio data for the first portion 802 is transmitted). As discussed herein, although only an encoding and the transcription are illustrated in FIG. 9, in some implementations, an audio data snippet (e.g., of the first portion 802) may be generated in addition to the encoding and the transcription.

In the examples of FIGS. 8 and 9, the first portion 802 and the first portion 900 are shown as extending from the beginning of a voice input 800. In other examples, the first portion 802 and/or the first portion 900 may be portions of the voice input that are spaced apart from the beginning of the voice input 800. For example, the first portion 802 and/or the first portion 900 may be selected based on the content of the voice input 800 (e.g., to include a high quality or low noise portion of the voice input 800, or to include a portion of the voice input 800 determined to be relevant to a particular encoding to be generated). It is also appreciated that, in some use cases (e.g., in the case of a long voice input, such as a long call), multiple separate portions of the voice input 800 may be encoded into audio data (e.g., periodically, or at times when the bit rate temporarily improves, such as in a use case in which a user of the electronic device 100 of FIG. 6 walks around while inputting voice data, occasionally moving to locations with an unobstructed communication path to the remote device 200), with transcription portions therebetween. In this way, additional audio snippets may be provided to the remote device that can “steer” the generative voice model at that device (e.g., to maintain its fidelity).

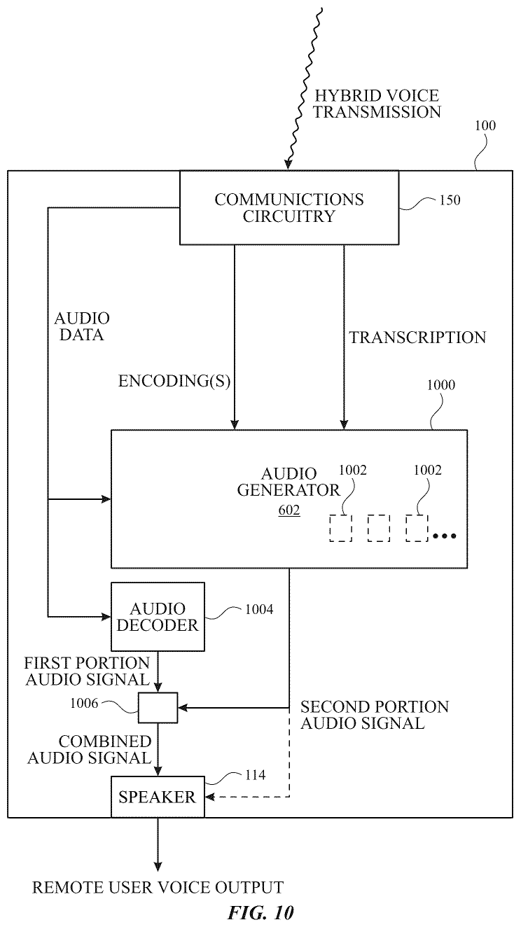

FIG. 10 illustrates a schematic block diagram of the electronic device 100 in a use case in which the electronic device 100 is generating a remote user voice output based on a hybrid voice transmission received wirelessly (e.g., by the communications circuitry 150, such as from the remote device 200). In the example of FIG. 10, a hybrid voice transmission is received at the communications circuitry 150. As discussed herein, a hybrid voice transmission may include a transcription of at least a portion of a voice input received at a remote device (e.g., a remote user voice input received at the remote device 200), one or more encodings of audio features of a voice of a remote user of the remote device, and/or audio data corresponding to a portion of the voice input received at the remote device.

As shown, the transcription, and one or both of the encoding(s) and/or the audio data may be provided to an audio generator 1000. As shown, the audio generator 1000 may include and/or may have access to one or more voice models 1002 that have been trained to generate an audio signal (e.g., a reconstructed-audio version of a voice input) responsive to receiving, as inputs, a transcription of a voice input and one or both of (i) one or more encodings of audio features of the voice input and/or (ii) audio data of a portion of a voice input. For example, the voice models 1002 may have been trained by adjusting one or more weights and/or other parameters of a respective neural network, based on comparisons (e.g., using a cost function) of training outputs generated by the voice models with training inputs, such as user voice samples.

In the example of FIG. 10, the audio generator 1000 receives, as inputs, the transcription corresponding to the second portion 804 and/or 902 of a remote user voice input (e.g., voice input 800) to the remote device 200, and one or both of (i) audio data corresponding to the first portion 802 of the remote user audio input and/or (ii) one or more encodings corresponding to the first portion 900 of the remote user audio input. As shown, even though the electronic device 100 only receives the transcription of the second portion 804 and/or 902 of the remote user voice input (e.g., without receiving audio data for that second portion), the audio generator 1000 generates a second portion audio signal (e.g., a reconstructed-audio version of the second portion 804 and/or 902 of the remote user voice input) for that the second portion 804 and/or 902. This second portion audio signal can be output by a speaker, such as speaker 114, of the electronic device 100 to generate a remote user voice output in a reconstructed voice of the remote user. As shown, in implementations in which audio data corresponding to the first portion 802 of the remote user audio input is received in the hybrid voice transmission, the audio data may also be provided to an audio decoder 1004. As shown, the audio decoder may generate a first portion audio signal (e.g., an audio version of the first portion 802 of the remote user voice input), which can a combined (e.g., by a combiner 1006) with the second portion audio signal (e.g., a reconstructed-audio version of the second portion of the remote user voice input) to generate a combined audio signal corresponding to the complete remote user voice output. In other implementations in which the audio data is not received, the second portion audio signal may include a reconstructed-audio version of the entire remote user voice input (e.g., generated using a transcription of the entire remote user voice input), which may be provided for output by the speaker 114 (e.g., without combination with a separate first portion audio signal).

The voice models 1002 may include a voice model of a generic person (e.g., trained using training data from a population of users, which may not include the user of the electronic device 100 or the remote device 200). For example, a voice model of a generic person may generate, responsive to receiving only a transcription (e.g., a text-only representation of the content of a voice input), an audio signal that, when output by a speaker, such as the speaker 114, sounds like a generic person (e.g., not the remote user of the remote device 200) speaking the words in the transcription. In one or more implementations, a voice model of a generic person may be able to, responsive to receiving a transcription in combination with an audio data snippet and/or one or more encodings of a remote user's voice received from the remote device, generate an audio signal that, when output by a speaker, such as speaker 114, mimics the sound of the remote user's voice speaking the words in the transcription. For example, the audio generator 1000 may perform a real-time, or on-the-fly, enrollment operation for a voice model 1002 using the audio data corresponding to the first portion of the remote user voice input as a first input to the voice model 1002 (e.g., as training data for the voice model). The audio generator 1000 may then, following the on-the-fly enrollment of the voice model 1002, provide the transcription data for the second potion of the remote user voice input as a second input to the voice model 1002 to generate the second portion audio signal.

The voice models 1002 may also, or alternatively, include voice models of specific users, such as friends and/or family members of the local user of the electronic device 100. In one or more implementations, these voice models for specific users may each be securely stored in connection with an identifier of the corresponding user. For example, the voice models 1002 may include, with the explicit permission of the remote user, a voice model that has been trained on the voice of the remote user of the remote device 200. For example, the remote user may provide voice input samples (e.g., by speaking one or more words or phrases, as prompted by the electronic device 100 or the remote device 200, into the electronic device 100 or the remote device 200) that are used to train a voice model 1002 specifically for the voice of the remote user. In one or more implementations, an identifier of a user of a remote device may be received in a hybrid voice transmission, and may be used to select a voice model 1002 for the identified user from multiple voice models 1002 stored at the electronic device 100.

In an implementation in which the audio generator 1000 includes a voice model 1002 that has been pre-trained for the remote user, the audio generator 1000 may generate, responsive to receiving only a transcription (e.g., without receiving any audio date or any encodings), a second portion audio signal that, when output by a speaker, such as the speaker 114, mimics a voice of the remote user speaking the words in the transcription. In this example, the remote user voice output that is generated by the speaker 114 may reflect a general sound of the voice of the remote user, without reflecting any current modifications to the voice of the user (e.g., due to a current physical state and/or condition of the remote user when the remote use spoke the remote user voice input). However, in an implementation in which the audio generator 1000 includes a voice model 1002 that has been pre-trained for the remote user and that, as inputs, receives a transcription and one or both of (i) audio data corresponding to a first portion 802 of a remote user voice input and/or (ii) one or more encodings corresponding to audio features of a first portion 900 of the remote user voice input, the audio generator 1000 may generate a second portion audio signal that, when output by a speaker, such as the speaker 114, mimics the current voice (e.g., in a current physical state and/or condition of the remote user) of the remote user speaking the words in the transcription.

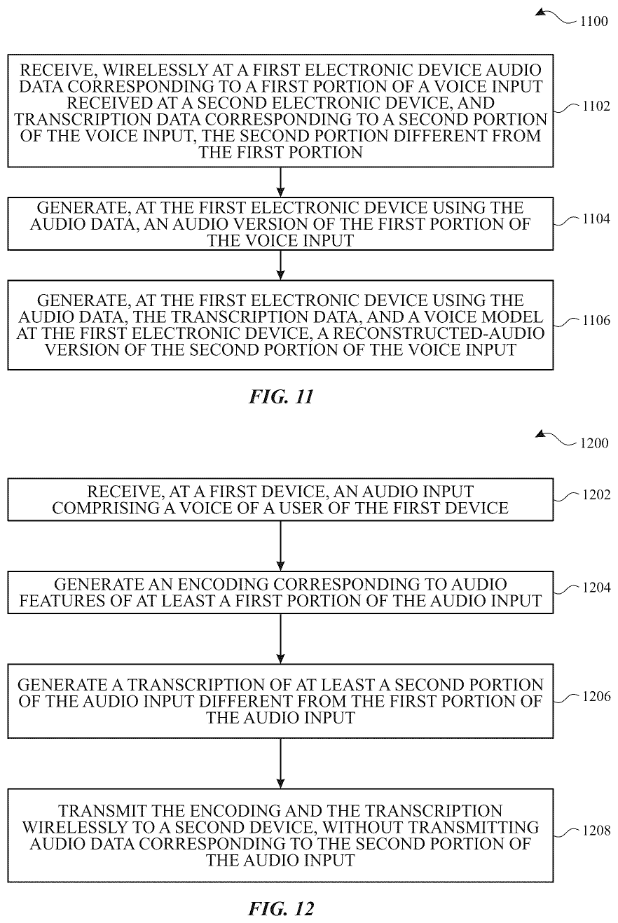

FIG. 11 illustrates a flow diagram of an example process for generating a remote user voice output based on a hybrid voice transmission, in accordance with one or more implementations. For explanatory purposes, the process 1100 is primarily described herein with reference to the electronic device 100 of FIGS. 1-7 and 10. However, the process 1100 is not limited to the electronic device 100 of FIGS. 1-7 and 10, and one or more blocks (or operations) of the process 1100 may be performed by one or more other components and other suitable devices. Further for explanatory purposes, the blocks of the process 1100 are described herein as occurring in serial, or linearly. However, multiple blocks of the process 1100 may occur in parallel. In addition, the blocks of the process 1100 need not be performed in the order shown and/or one or more blocks of the process 1100 need not be performed and/or can be replaced by other operations.

In the example of FIG. 11, at block 1102, a first electronic device (e.g., electronic device 100) may wirelessly receive (e.g., in a hybrid voice transmission transmitted by a second electronic device) audio data corresponding to a first portion (e.g., first portion 802) of a voice input (e.g., local user voice input 800) received at (e.g., a microphone of) a second electronic device (e.g., remote device 200), and transcription data (e.g., a text-only representation of words spoken by a remote user during the voice input) corresponding to a second portion (e.g., second portion 804) of the voice input, the second portion different from the first portion. For example, the voice input may have a length in time, and the first portion may include a time segment of less than ten percent of the length in time (e.g., as shown in the example of FIG. 8).

In one or more implementations, receiving the audio data and the transcription data may include receiving the audio data and the transcription data via a satellite (e.g., satellite 204 of FIG. 3). In one or more implementations, receiving the audio data and the transcription data may include receiving the audio data and the transcription data at a rate of less than five hundred bits per second.

At block 1104, the first electronic device (e.g., audio decoder 1004) may generate, using the audio data (e.g., by reversing an encoding that was performed by an encoder at the second electronic device to generate the audio data from an audio signal), an audio version (e.g., a first portion audio signal) of the first portion of the voice input.

At block 1106, the first electronic device (e.g., audio generator 1000) may generate, using the audio data, the transcription data, and a voice model (e.g., a voice model 1002) at the first electronic device, a reconstructed-audio version of the second portion of the voice input (e.g., a second portion audio signal). For example, generating the reconstructed-audio version of the second portion of the voice input may include generating the reconstructed-audio version of the second portion of the voice input without receiving or using audio data corresponding to the second portion of the voice input. In one or more implementations, generating the reconstructed-audio version of the second portion of the voice input may include providing the audio data and the transcription data to the voice model as inputs, and obtaining an output of the voice model as the reconstructed-audio version of the second portion of the voice input. In one or more implementations, generating the reconstructed-audio version of the second portion of the voice input may include providing the audio data as a first input to the voice model; performing an enrollment operation to train the voice model using the audio data; providing the transcription data as a second input to the voice model following the enrollment operation; and obtaining an output of the voice model as the reconstructed-audio version of the second portion of the voice input.

In one or more implementations, the first electronic device may also generate, with a speaker (e.g., speaker 114) of the first electronic device, an audio output (e.g., a remote user voice output) that includes a first part (e.g., corresponding to a first portion 802 of a remote user voice input provided to the second electronic device) generated using the audio version of the first portion of the voice input and including a recorded sound of a voice of a user of the second electronic device, and a second part (e.g., corresponding to a second portion 804 of a remote user voice input provided to the second electronic device) corresponding to the reconstructed-audio version of the second portion of the voice input and including a computer-generated sound that mimics the voice of the user of the second electronic device.

In one or more implementations, the voice input includes one or more voice characteristics (e.g., prosody, tone, stress, timbre, rhythm or the like) of a voice of a user of the second electronic device, and generating the reconstructed-audio version of the second portion of the voice input at block 1106 includes generating the reconstructed-audio version of the second portion of the voice input to mimic the one or more voice characteristics of voice of the user.

In one or more implementations, the voice model at the first electronic device has been trained, prior to receiving the audio data or the transcription data, at least in part based on a voice of a user of the second electronic device.

In one or more implementations, the first electronic device may also receive an encoding associated with a voice of a user of the second electronic device. In these implementations, generating the reconstructed-audio version of the second portion of the voice input may include generating the reconstructed-audio version of the second portion of the voice input using the audio data, the transcription data, the voice model, and the encoding (e.g., by providing the encoding to the voice model along with the transcription and/or the audio data). For example, the encoding may include at least one of: a prosody encoding, a semantic encoding, a tone encoding, a stress encoding, a rhythm encoding, a timbre encoding, or an ambience encoding.

FIG. 12 illustrates a flow diagram of an example process for generating a hybrid voice transmission based on a local user voice input, in accordance with one or more implementations. For explanatory purposes, the process 1200 is primarily described herein with reference to the electronic device 100 of FIGS. 1-7 and 10. However, the process 1200 is not limited to the electronic device 100 of FIG. 1 of FIGS. 1-7 and 10, and one or more blocks (or operations) of the process 1200 may be performed by one or more other components and other suitable devices. Further for explanatory purposes, the blocks of the process 1200 are described herein as occurring in serial, or linearly. However, multiple blocks of the process 1200 may occur in parallel. In addition, the blocks of the process 1200 need not be performed in the order shown and/or one or more blocks of the process 1200 need not be performed and/or can be replaced by other operations.

In the example of FIG. 12, at block 1202, a first device (e.g., electronic device 100) may receive an audio input (e.g., a local user voice input) that includes a voice of a user of the first device. For example, the local user of the first device may speak one or more words (e.g., for a message) into, toward, and/or in the vicinity of the first device, and the voice of the local user may be received by one or more microphones (e.g., microphone(s) 115) of the first device as the audio input.

At block 1204, the first device (e.g., audio encoder 602 and/or the feature extractor 700) may generate an encoding corresponding to audio features of at least a first portion (e.g., first portion 802 of FIG. 8 or first portion 900 of FIG. 9) of the audio input. For example, the encoding may include at least one of: an audio encoding (e.g., generated by the audio encoder 602), a prosody encoding, a semantic encoding, a tone encoding, a stress encoding, a rhythm encoding, a timbre encoding, or an ambience encoding (e.g., generated by the feature extractor 700).

At block 1206, the first device (e.g., speech-to-text block 604) may generate a transcription of at least a second portion of the audio input different from the first portion of the audio input. For example, the first portion of the audio input may include a first time segment of the audio input, and the second portion of the audio input may include a second time segment of the audio input (e.g., as shown in FIGS. 8 and 9). For example, the transcription may be a text-only representation of the words spoken by the local user, without any information about the sound or characteristics of the voice of the local user.

At block 1208, the first device may transmit (e.g., in a hybrid voice transmission) the encoding and the transcription wirelessly to a second device (e.g., remote device 200), without transmitting audio data corresponding to the second portion of the audio input (e.g., in contrast with a video conferencing application that sends the entire audio along with a transcription of the entire audio).

In one or more implementations, the first device may select, based on an available bandwidth (e.g., or data rate) for wireless transmission from the first device, the encoding from among the audio encoding, the prosody encoding, the semantic encoding, the tone encoding, the stress encoding, the rhythm encoding, the timbre encoding, or the ambience encoding. For example, the audio encoding may be selected in relatively higher bandwidth network environments (e.g., capable of transmitting more than a few hundred bits per second, such as when the first device has access to a network capable of transmitting between ten and thirty kilobits per second), and, in relatively lower bandwidth network environments (e.g., capable of transmitting less than one kilobit per second, or less than five hundred bits per second), one or more of the prosody encoding, the semantic encoding, the tone encoding, the stress encoding, the rhythm encoding, the timbre encoding, or the ambience encoding may be selected. In one or more implementations, after transmitting the encoding and the transcription, the first device may detect a high-bandwidth network environment (e.g., capable of data rates greater than a few hundred bits per second, or between ten and thirty kilobits per second, such as in the examples of FIGS. 2 and 4), and audio data of an entire subsequent voice input to the first device may be transmitted (e.g., without encodings and/or transcriptions) while the first device is in the high-bandwidth network environment.

In one or more implementations, the first device may select, based on one or more voice-reconstruction attributes of the second device (e.g., based on a size of a voice model at the second device, and/or based on whether the second device has a voice model that has been trained for the user of the first device), the encoding from among the audio encoding, the prosody encoding, the semantic encoding, the tone encoding, the stress encoding, the rhythm encoding, the timbre encoding, or the ambience encoding. For example, fewer (e.g., a subset) of the above encodings may be transmitted when a larger voice model or a voice model pre-trained for the user of the first device is available at the second device.

In one or more implementations, generating the encoding at block 1204 may include generating an audio encoding (e.g., with the audio encoder 602) corresponding to the audio features of the first portion of the audio input without generating an audio encoding of the second portion of the audio input.

In one or more implementations, generating the encoding at block 1204 may include generating the encoding corresponding to the audio features of the first portion (e.g., first portion 900) of the audio input and audio features of the second portion (e.g., second portion 902) of the audio input, generating the transcription at block 1206 may include generating a transcription of the first portion of the audio input and the transcription of the second portion of the audio input, and transmitting the encoding and the transcription wirelessly to the second device, without transmitting the audio data corresponding the second portion of the audio input at block 1208, may include transmitting the encoding and the transcription wirelessly to the second device without transmitting any audio data corresponding to the audio input. For example, each of the encoding and the transcription may be generated based on the entire audio input in some use cases.

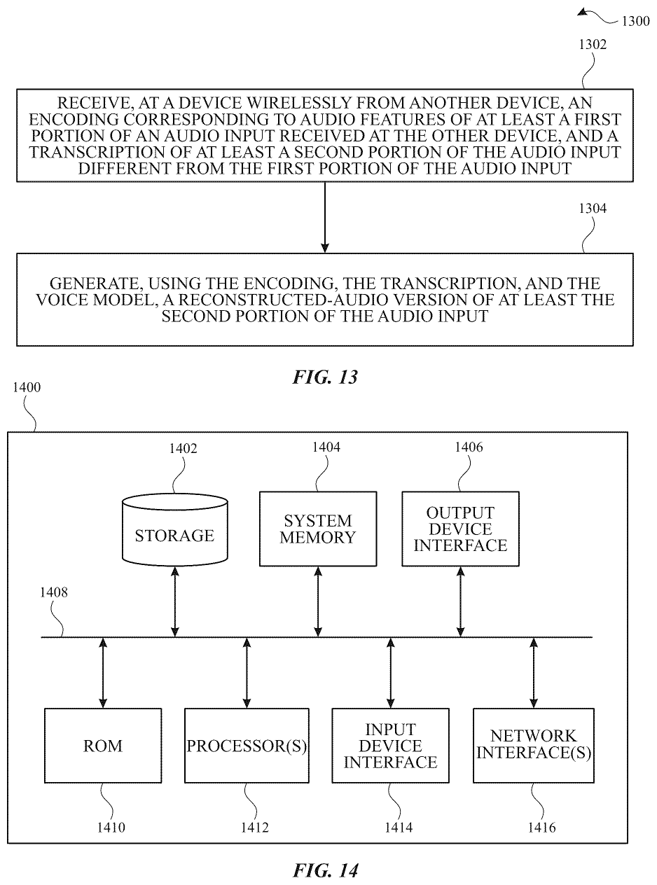

FIG. 13 illustrates a flow diagram of an example process for generating a remote user voice output based on a hybrid voice transmission based, in accordance with one or more implementations. For explanatory purposes, the process 1300 is primarily described herein with reference to the electronic device 100 of FIGS. 1-7 and 10. However, the process 1300 is not limited to the electronic device 100 of FIG. 1 of FIGS. 1-7 and 10, and one or more blocks (or operations) of the process 1300 may be performed by one or more other components and other suitable devices. Further for explanatory purposes, the blocks of the process 1300 are described herein as occurring in serial, or linearly. However, multiple blocks of the process 1300 may occur in parallel. In addition, the blocks of the process 1300 need not be performed in the order shown and/or one or more blocks of the process 1300 need not be performed and/or can be replaced by other operations.

In the example of FIG. 13, at block 1302, a first device (e.g., electronic device 100) may receive (e.g., in a hybrid voice transmission), wirelessly from another device (e.g., remote device 200): an encoding corresponding to audio features of at least a first portion (e.g., first portion 900) of an audio input (e.g., local user voice input 800) received at the other device, and a transcription of at least a second portion (e.g., second portion 902) of the audio input different from the first portion of the audio input.

At block 1304, the first device may generate, using the encoding, the transcription, and a voice model (e.g., a voice model 1002 stored in memory at the first device), a reconstructed-audio version (e.g., a second portion audio signal) of at least the second portion of the audio input. The first device may then output the reconstructed-audio version of the at least the second portion of the audio input. In one or more implementations, the first portion may include a fraction of the audio input, and the second portion may include the entire audio input. The audio input may be a voice input that includes a voice of a user of the other device speaking words.

In one or more implementations, the first device may also receive, from the other device, an identifier of a user of the other device, and may generate the reconstructed-audio version of at least the second portion of the audio input using the encoding, the transcription, the voice model, and the identifier. For example, the voice model may have been previously trained on a voice of the user of the other device, and generating the reconstructed-audio version of at least the second portion of the audio input using the encoding, the transcription, the voice model, and the identifier may include selecting the voice model from a plurality of voice models at the device (e.g., and then generating the reconstructed-audio version using the selected voice model).

As described above, one aspect of the present technology is the gathering and use of data available from specific and legitimate sources for providing user information in association with processing audio and/or non-audio signals. The present disclosure contemplates that in some instances, this gathered data may include personal information data that uniquely identifies or can be used to identify a specific person. Such personal information data can include voice data, demographic data, location-based data, online identifiers, telephone numbers, email addresses, home addresses, data or records relating to a user's health or level of fitness (e.g., vital signs measurements, medication information, exercise information), date of birth, or any other personal information.

The present disclosure recognizes that the use of such personal information data, in the present technology, can be used to the benefit of users. For example, the personal information data can be used for providing efficient voice communications for electronic devices.

Accordingly, use of such personal information data may facilitate transactions (e.g., on-line transactions). Further, other uses for personal information data that benefit the user are also contemplated by the present disclosure. For instance, health and fitness data may be used, in accordance with the user's preferences to provide insights into their general wellness, or may be used as positive feedback to individuals using technology to pursue wellness goals.

The present disclosure contemplates that those entities responsible for the collection, analysis, disclosure, transfer, storage, or other use of such personal information data will comply with well-established privacy policies and/or privacy practices. In particular, such entities would be expected to implement and consistently apply privacy practices that are generally recognized as meeting or exceeding industry or governmental requirements for maintaining the privacy of users. Such information regarding the use of personal data should be prominently and easily accessible by users, and should be updated as the collection and/or use of data changes. Personal information from users should be collected for legitimate uses only. Further, such collection/sharing should occur only after receiving the consent of the users or other legitimate basis specified in applicable law. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations which may serve to impose a higher standard. For instance, in the US, collection of or access to certain health data may be governed by federal and/or state laws, such as the Health Insurance Portability and Accountability Act (HIPAA); whereas health data in other countries may be subject to other regulations and policies and should be handled accordingly.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of providing efficient voice communications for electronic devices, the present technology can be configured to allow users to select to “opt in” or “opt out” of participation in the collection of personal information data during registration for services or anytime thereafter. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing identifiers, controlling the amount or specificity of data stored (e.g., collecting location data at city level rather than at an address level), controlling how data is stored (e.g., aggregating data across users), and/or other methods such as differential privacy.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data.

FIG. 14 illustrates an electronic system 1400 with which one or more implementations of the subject technology may be implemented. The electronic system 1400 can be, and/or can be a part of, one or more of the electronic device 100 shown in FIG. 1-7 and 10 and/or the remote device 200 shown in FIGS. 2-5. The electronic system 1400 may include various types of computer readable media and interfaces for various other types of computer readable media. The electronic system 1400 includes a bus 1408, one or more processing unit(s) 1412, a system memory 1404 (and/or buffer), a read-only memory (ROM) 1410, a permanent storage device 1402, an input device interface 1414, an output device interface 1406, and one or more network interfaces 1416, or subsets and variations thereof.

The bus 1408 collectively represents all system, peripheral, and chipset buses that communicatively connect the numerous internal devices of the electronic system 1400. In one or more implementations, the bus 1408 communicatively connects the one or more processing unit(s) 1412 with the ROM 1410, the system memory 1404, and the permanent storage device 1402. From these various memory units, the one or more processing unit(s) 1412 retrieves instructions to execute and data to process in order to execute the processes of the subject disclosure. The one or more processing unit(s) 1412 can be a single processor or a multi-core processor in different implementations.

The ROM 1410 may store static data and instructions that are needed by the one or more processing unit(s) 1412 and other modules of the electronic system 1400. The permanent storage device 1402, on the other hand, may be a read-and-write memory device. The permanent storage device 1402 may be a non-volatile memory unit that stores instructions and data even when the electronic system 1400 is off. In one or more implementations, a mass-storage device (such as a magnetic or optical disk and its corresponding disk drive) may be used as the permanent storage device 1402.

In one or more implementations, a removable storage device (such as a floppy disk, flash drive, and its corresponding disk drive) may be used as the permanent storage device 1402. Like the permanent storage device 1402, the system memory 1404 may be a read-and-write memory device. However, unlike the permanent storage device 1402, the system memory 1404 may be a volatile read-and-write memory, such as random access memory. The system memory 1404 may store any of the instructions and data that one or more processing unit(s) 1412 may need at runtime. In one or more implementations, the processes of the subject disclosure are stored in the system memory 1404, the permanent storage device 1402, and/or the ROM 1410.

From these various memory units, the one or more processing unit(s) 1412 retrieves instructions to execute and data to process in order to execute the processes of one or more implementations.

The bus 1408 also connects to the input and output device interfaces 1414 and 1406.

The input device interface 1414 enables a user to communicate information and select commands to the electronic system 1400. Input devices that may be used with the input device interface 1414 may include, for example, microphones, alphanumeric keyboards and pointing devices (also called “cursor control devices”). The output device interface 1406 may enable, for example, the display of images generated by electronic system 1400. Output devices that may be used with the output device interface 1406 may include, for example, printers and display devices, such as a liquid crystal display (LCD), a light emitting diode (LED) display, an organic light emitting diode (OLED) display, a flexible display, a flat panel display, a solid state display, a projector, a speaker or speaker module, or any other device for outputting information. One or more implementations may include devices that function as both input and output devices, such as a touchscreen. In these implementations, feedback provided to the user can be any form of sensory feedback, such as visual feedback, auditory feedback, or tactile feedback; and input from the user can be received in any form, including acoustic, speech, or tactile input.

Finally, as shown in FIG. 14, the bus 1408 also couples the electronic system 1400 to one or more networks and/or to one or more network nodes through the one or more network interface(s) 1416. In this manner, the electronic system 1400 can be a part of a network of computers (such as a LAN, a wide area network (“WAN”), or an Intranet, or a network of networks, such as the Internet. Any or all components of the electronic system 1400 can be used in conjunction with the subject disclosure.

The computer-readable storage medium can be any storage medium that can be read, written, or otherwise accessed by a general purpose or special purpose computing device, including any processing electronics and/or processing circuitry capable of executing instructions. For example, without limitation, the computer-readable medium can include any volatile semiconductor memory, such as RAM, DRAM, SRAM, T-RAM, Z-RAM, and TTRAM. The computer-readable medium also can include any non-volatile semiconductor memory, such as ROM, PROM, EPROM, EEPROM, NVRAM, flash, nvSRAM, FeRAM, FeTRAM, MRAM, PRAM, CBRAM, SONOS, RRAM, NRAM, racetrack memory, FJG, and Millipede memory.

Further, the computer-readable storage medium can include any non-semiconductor memory, such as optical disk storage, magnetic disk storage, magnetic tape, other magnetic storage devices, or any other medium capable of storing one or more instructions. In one or more implementations, the tangible computer-readable storage medium can be directly coupled to a computing device, while in other implementations, the tangible computer-readable storage medium can be indirectly coupled to a computing device, e.g., via one or more wired connections, one or more wireless connections, or any combination thereof.

Instructions can be directly executable or can be used to develop executable instructions. For example, instructions can be realized as executable or non-executable machine code or as instructions in a high-level language that can be compiled to produce executable or non-executable machine code. Further, instructions also can be realized as or can include data.

Computer-executable instructions also can be organized in any format, including routines, subroutines, programs, data structures, objects, modules, applications, applets, functions, etc. As recognized by those of skill in the art, details including, but not limited to, the number, structure, sequence, and organization of instructions can vary significantly without varying the underlying logic, function, processing, and output.

While the above discussion primarily refers to microprocessor or multi-core processors that execute software, one or more implementations are performed by one or more integrated circuits, such as ASICs or FPGAs. In one or more implementations, such integrated circuits execute instructions that are stored on the circuit itself.

Various functions described above can be implemented in digital electronic circuitry, in computer software, firmware or hardware. The techniques can be implemented using one or more computer program products. Programmable processors and computers can be included in or packaged as mobile devices. The processes and logic flows can be performed by one or more programmable processors and by one or more programmable logic circuitry. General and special purpose computing devices and storage devices can be interconnected through communication networks.

Some implementations include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, ultra density optical discs, any other optical or magnetic media, and floppy disks. The computer-readable media can store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

As used in this specification and any claims of this application, the terms “computer”, “processor”, and “memory” all refer to electronic or other technological devices. These terms exclude people or groups of people. For the purposes of the specification, the terms “display” or “displaying” means displaying on an electronic device. As used in this specification and any claims of this application, the terms “computer readable medium” and “computer readable media” are entirely restricted to tangible, physical objects that store information in a form that is readable by a computer. These terms exclude any wireless signals, wired download signals, and any other ephemeral signals.

Many of the above-described features and applications are implemented as software processes that are specified as a set of instructions recorded on a computer readable storage medium (also referred to as computer readable medium). When these instructions are executed by one or more processing unit(s) (e.g., one or more processors, cores of processors, or other processing units), they cause the processing unit(s) to perform the actions indicated in the instructions. Examples of computer readable media include, but are not limited to, CD-ROMs, flash drives, RAM chips, hard drives, EPROMs, etc. The computer readable media does not include carrier waves and electronic signals passing wirelessly or over wired connections.

In this specification, the term “software” is meant to include firmware residing in read-only memory or applications stored in magnetic storage, which can be read into memory for processing by a processor. Also, in some implementations, multiple software aspects of the subject disclosure can be implemented as sub-parts of a larger program while remaining distinct software aspects of the subject disclosure. In some implementations, multiple software aspects can also be implemented as separate programs. Finally, any combination of separate programs that together implement a software aspect described here is within the scope of the subject disclosure. In some implementations, the software programs, when installed to operate on one or more electronic systems, define one or more specific machine implementations that execute and perform the operations of the software programs.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

It is understood that any specific order or hierarchy of blocks in the processes disclosed is an illustration of example approaches. Based upon design preferences, it is understood that the specific order or hierarchy of blocks in the processes may be rearranged, or that all illustrated blocks be performed. Some of the blocks may be performed simultaneously. For example, in certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

The predicate words “configured to”, “operable to”, and “programmed to” do not imply any particular tangible or intangible modification of a subject, but, rather, are intended to be used interchangeably. For example, a processor configured to monitor and control an operation or a component may also mean the processor being programmed to monitor and control the operation or the processor being operable to monitor and control the operation.

Likewise, a processor configured to execute code can be construed as a processor programmed to execute code or operable to execute code.

A phrase such as an “aspect” does not imply that such aspect is essential to the subject technology or that such aspect applies to all configurations of the subject technology. A disclosure relating to an aspect may apply to all configurations, or one or more configurations. A phrase such as an aspect may refer to one or more aspects and vice versa. A phrase such as a “configuration” does not imply that such configuration is essential to the subject technology or that such configuration applies to all configurations of the subject technology. A disclosure relating to a configuration may apply to all configurations, or one or more configurations. A phrase such as a configuration may refer to one or more configurations and vice versa.

The word “example” is used herein to mean “serving as an example or illustration.” Any aspect or design described herein as “example” is not necessarily to be construed as preferred or advantageous over other aspects or design.

In one aspect, a term coupled or the like may refer to being directly coupled. In another aspect, a term coupled or the like may refer to being indirectly coupled.

Terms such as top, bottom, front, rear, side, horizontal, vertical, and the like refer to an arbitrary frame of reference, rather than to the ordinary gravitational frame of reference. Thus, such a term may extend upwardly, downwardly, diagonally, or horizontally in a gravitational frame of reference.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f), unless the element is expressly recited using the phrase “means for” or, in the case of a method claim, the element is recited using the phrase “step for.” Furthermore, to the extent that the term “include,” “have,” or the like is used in the description or the claims, such term is intended to be inclusive in a manner similar to the term “comprise” as “comprise” is interpreted when employed as a transitional word in a claim.

What is claimed is:

1. A method, comprising:
receiving, wirelessly at a first electronic device:
audio data corresponding to a first portion of a voice input received at a second electronic device, and
transcription data corresponding to a second portion of the voice input, the second portion different from the first portion; and
generating, at the first electronic device using the audio data, an audio version of the first portion of the voice input; and
generating, at the first electronic device using the audio data, the transcription data, and a voice model at the first electronic device, a reconstructed-audio version of the second portion of the voice input.

2. The method of claim 1, further comprising generating, with a speaker of the first electronic device, an audio output comprising:
a first part generated using the audio version of the first portion of the voice input and comprising a recorded sound of a voice of a user of the second electronic device; and
a second part corresponding to the reconstructed-audio version of the second portion of the voice input and comprising a computer-generated sound that mimics the voice of the user of the second electronic device.

3. The method of claim 1, wherein generating the reconstructed-audio version of the second portion of the voice input comprises generating the reconstructed-audio version of the second portion of the voice input without receiving or using audio data corresponding to the second portion of the voice input.

4. The method of claim 1, wherein generating the reconstructed-audio version of the second portion of the voice input comprises:
providing the audio data and the transcription data to the voice model as inputs; and
obtaining an output of the voice model as the reconstructed-audio version of the second portion of the voice input.

5. The method of claim 4, wherein generating the reconstructed-audio version of the second portion of the voice input comprises:
providing the audio data as a first input to the voice model;
performing an enrollment operation to train the voice model using the audio data;
providing the transcription data as a second input to the voice model following the enrollment operation; and
obtaining an output of the voice model as the reconstructed-audio version of the second portion of the voice input.

6. The method of claim 1, wherein the voice input includes one or more voice characteristics of a voice of a user of the second electronic device, and wherein generating the reconstructed-audio version of the second portion of the voice input comprises generating the reconstructed-audio version of the second portion of the voice input to mimic the one or more voice characteristics of voice of the user.

7. The method of claim 1, wherein the voice model at the first electronic device has been trained, prior to receiving the audio data or the transcription data, at least in part based on a voice of a user of the second electronic device.

8. The method of claim 1, wherein receiving the audio data and the transcription data comprises receiving the audio data and the transcription data via a satellite.

9. The method of claim 1, wherein receiving the audio data and the transcription data comprises receiving the audio data and the transcription data at an average rate of less than five hundred bits per second.

10. The method of claim 1, wherein the voice input comprises a length in time, and wherein the first portion comprises a time segment of less than ten percent of the length in time.

11. The method of claim 1, further comprising receiving, at the first electronic device, an encoding associated with a voice of a user of the second electronic device, wherein generating the reconstructed-audio version of the second portion of the voice input comprises generating the reconstructed-audio version of the second portion of the voice input using the audio data, the transcription data, the voice model, and the encoding, and wherein the encoding comprises at least one of: a prosody encoding, a semantic encoding, a tone encoding, a stress encoding, a rhythm encoding, a timbre encoding, or an ambience encoding.

12. A method, comprising:
receiving, at a first device, an audio input comprising a voice of a user of the first device;
generating an encoding corresponding to audio features of at least a first portion of the audio input;
generating a transcription of at least a second portion of the audio input different from the first portion of the audio input; and
transmitting the encoding and the transcription wirelessly to a second device, without transmitting audio data corresponding to the second portion of the audio input.

13. The method of claim 12, wherein the encoding comprises at least one of: an audio encoding, a prosody encoding, a semantic encoding, a tone encoding, a stress encoding, a rhythm encoding, a timbre encoding, or an ambience encoding.

14. The method of claim 13, further comprising selecting, based on an available bandwidth for wireless transmission from the first device, the encoding from among the audio encoding, the prosody encoding, the semantic encoding, the tone encoding, the stress encoding, the rhythm encoding, the timbre encoding, and the ambience encoding.

15. The method of claim 13, further comprising selecting, based on one or more voice-reconstruction attributes of the second device, the encoding from among the audio encoding, the prosody encoding, the semantic encoding, the tone encoding, the stress encoding, the rhythm encoding, the timbre encoding, and the ambience encoding.

16. The method of claim 12, wherein the first portion of the audio input comprises a first time segment of the audio input, and wherein the second portion of the audio input comprises a second time segment of the audio input.

17. The method of claim 16, wherein generating the encoding comprises generating the encoding corresponding to the audio features of the first portion of the audio input and audio features of the second portion of the audio input, wherein generating the transcription comprises generating a transcription of the first portion of the audio input and the transcription of the second portion of the audio input, and wherein transmitting the encoding and the transcription wirelessly to the second device, without transmitting the audio data corresponding the second portion of the audio input, comprises transmitting the encoding and the transcription wirelessly to the second device without transmitting any audio data corresponding to the audio input.

18. The method of claim 16, wherein generating the encoding comprises generating an audio encoding corresponding to the audio features of the first portion of the audio input without generating an audio encoding of the second portion of the audio input.

19. A device, comprising:
a memory storing a voice model; and
one or more processors configured to:
receive, wirelessly from an other device:
an encoding corresponding to audio features of at least a first portion of an audio input received at the other device; and
a transcription of at least a second portion of the audio input different from the first portion of the audio input; and
generate, using the encoding, the transcription, and the voice model, a reconstructed-audio version of at least the second portion of the audio input.

20. The device of claim 19, wherein the one or more processors are further configured to:
receive, from the other device, an identifier of a user of the other device; and
generate the reconstructed-audio version of at least the second portion of the audio input by generating the reconstructed-audio version of at least the second portion of the audio input using the encoding, the transcription, the voice model, and the identifier.

21. The device of claim 20, wherein the voice model has been previously trained on a voice of the user of the other device, and wherein generating the reconstructed-audio version of at least the second portion of the audio input using the encoding, the transcription, the voice model, and the identifier comprises selecting the voice model from a plurality of voice models at the device.
